(19) United States
(12) Patent Application Publication
(10) Pub. No.: US 2026/0336696 A1
(43) Pub. Date: Oct. 29, 2026

(54) Method and Device for Estimating a Steering Variable

(71) Applicant: Robert Bosch GmbH, Stuttgart (DE)

(72) Inventors: Lucas Eduardo Hechfellner Litcanov, Muenchen (DE); Maximilian Vogt, Muenchen (DE); Stefan Falkner, Blankenburg (DE)

(21) Appl. No.: 19/658,493

(22) Filed: Apr. 25, 2026

(30) Foreign Application Priority Data
Apr. 28, 2025 (DE) 10 2025 116 161.5

(51) Int. Cl. B62D 15/02

(52) U.S. Cl. CPC B62D 15/021

(57) ABSTRACT

A method for estimating a steering variable of a steering system of a vehicle includes (i) providing a foundation model structured as an encoder-decoder, (ii) supplying a reference input to the encoder of the foundation model, wherein the reference input includes physical and/or dynamic properties of the vehicle, (iii) supplying a trajectory input to the decoder of the foundation model, wherein the trajectory input includes a trajectory of a simulation of the vehicle, (iv) processing the reference input and the trajectory input by the foundation model, wherein the encoder converts the physical and/or dynamic properties of the vehicle into a latent representation in a representation space and the decoder combines the trajectory inputs with the latent representation, and (v) estimating the steering variable of the vehicle by the foundation model, based on the reference input for the given trajectory.

This application claims priority under 35 U.S.C. § 119 to patent application no. DE 10 2025 116 161.5, filed on Apr. 28, 2025 in Germany, the disclosure of which is incorporated herein by reference in its entirety.

The present disclosure relates to a method and device for estimating steering variables in vehicle steering systems, in particular in connection with predicting dynamic vehicle responses while driving.

### BACKGROUND

Modern vehicles are increasingly equipped with electronic control systems that require precise steering control. In doing so, precise knowledge of the forces and moments acting on the steering mechanism plays a decisive role in driving stability, vehicle safety, and driver assistance systems.

Particularly in simulation-based development processes and virtual test methods, it is necessary to estimate steering quantities as realistically as possible in order to precisely analyze different driving conditions and driving scenarios. A reliable calculation of these variables requires comprehensive consideration of vehicle dynamics, including physical interactions between the vehicle, the roadway, and external influences. In this context, both longitudinal and lateral dynamic factors are important, as they have a direct impact on the force relationships within the steering.

Increasingly, data-driven models are used in vehicle technology to model complex dynamic relationships. Such models are often based on extensive physical calculations or numerical simulations, which may be associated with high computational cost. At the same time, interest in machine learning methods for improving predictive accuracy and reducing computation times is increasing. The combination of data-based and physical methods provides the potential to further improve the efficiency and accuracy of steering variable estimates.

Given these challenges, there is a need for improved methods for accurately and efficiently estimating steering variables that allow for realistic modeling of vehicle dynamics and that can be used in various applications, including simulations, control systems, and driver assistance systems.

It is an object of the disclosure to provide an improved method and/or apparatus in this respect.

The problem is solved with a method according to the features set forth below. The problem is further solved by an apparatus according to the features set forth below.

### SUMMARY

According to a first aspect, a method for estimating a steering variable of a steering system of a vehicle or a robot is proposed. The method comprises the steps of:
providing a foundation model structured as an encoder-decoder;
supplying a reference input to the encoder of the foundation model, wherein the reference input comprises physical and/or dynamic properties of the vehicle or the robot;
supplying a trajectory input to the decoder of the foundation model, wherein the trajectory input comprises a trajectory of a simulation of the vehicle or the robot;
processing the reference input and the trajectory input by the foundation model, wherein the encoder converts the physical and/or dynamic properties of the vehicle or the robot into a latent representation in a representation space, and the decoder combines the trajectory input with the latent representation; and
estimating the steering variable of the vehicle or the robot by the foundation model, based on the reference input for the given trajectory.

It is understood that the steps according to the disclosure and further optional steps do not necessarily have to be carried out in the order shown, but may also be carried out in a different order. Furthermore, intermediate steps may also be provided. The individual steps may also comprise one or more sub-steps without going beyond the scope of the method according to the disclosure.

According to a second aspect, a device for estimating a steering variable of a steering system of a vehicle or a robot is proposed. The device comprises an evaluation and calculation unit that is configured to perform the following steps:
providing a foundation model structured as an encoder-decoder;
supplying a reference input to the encoder of the foundation model, wherein the reference input comprises physical and/or dynamic properties of the vehicle or the robot;
supplying a trajectory input to the decoder of the foundation model, wherein the trajectory input comprises a trajectory of a simulation of the vehicle or the robot;
processing the reference input and the trajectory input by the foundation model, wherein the encoder converts the physical and/or dynamic properties of the vehicle into a latent representation in a representation space, and the decoder combines the trajectory input with the latent representation; and
estimating the steering variable of the vehicle or the robot by the foundation model, based on the reference input for the given trajectory.

The explanations given for the method apply to the apparatus accordingly. In this regard, any linguistic modifications of features formulated in terms of the method can be reformulated for the apparatus in accordance with standard linguistic practice, without such formulations having to be explicitly listed here.

The method preferably includes providing a foundation model structured as an encoder-decoder. A foundation model preferably refers to a pre-trained, generalized model that can be adapted for various specific tasks. As a substitute for a classical steering simulation, it preferably allows for efficient and data-based estimation of steering variables without the need for a complete physics-based model.

The encoder of the foundation model preferably receives a reference input comprising physical and/or dynamic properties of the vehicle or robot. Instead of a complete car model or robot model, as used in classical physics-based simulations, the reference input may preferably directly comprise the parameters relevant for the calculation. This preferably allows for more flexible and efficient modeling, as specific degrees of freedom or derived variables from the dynamics, such as rack force, can be specifically incorporated.

The decoder of the foundation model preferably receives a trajectory input that describes the trajectory of a simulation of the vehicle or robot. A trajectory preferably refers to a time-dependent motion curve representing the position and orientation of an object in space. By processing this input by the decoder, the model may preferably predict vehicle-dynamic responses resulting from a predetermined motion.

The method preferably comprises processing the reference input and the trajectory input by the foundation model, wherein the encoder converts the physical and/or dynamic properties of the vehicle or robot into a latent representation. A latent representation is preferably an abstract representation of the input data in a compressed feature space that allows for efficient further processing. This representation preferably serves as the basis for the decoder, which combines the trajectory input with the derived physical and dynamic information. This has the technical advantage that not all physical equations must be calculated explicitly, but the model can make a data-driven and optimized prediction of the relevant variables.

The method preferably comprises estimating a steering variable of the vehicle or the robot by the Foundation Model, based on the reference input for the given trajectory. A steering variable may preferably be a rack force, wherein other derived dynamic variables may also be considered. Preferably, the model may depict a full six-degree-of-freedom system of a vehicle or robot or, depending on the application, account for fewer degrees of freedom. This allows the method to be flexibly adapted to different requirements and enables a scalable calculation of steering variables with variable model complexity.

In another aspect, it is proposed that the foundation model be optimized by a structured training process in which the training data is purposefully divided into different categories. In so doing, maneuvers with particularly representative vehicle dynamics, in particular sinusoidal sweep maneuvers, are preferably kept separately for use as a reference input for the training. The remaining data preferably serve as labels and trajectory inputs so that pairs are formed from trajectory inputs and the corresponding reference inputs. This methodology, referred to as “maneuver mix” in the training process, enables an efficient model adjustment by the model learning to capture the relevant physical and dynamic properties of the vehicle or robot from the reference input and to use them in combination with the trajectory input for a precise estimation of the steering variable.

Model performance is evaluated by comparing different modeling approaches, wherein in particular hybrid structures, a physics-based single-track model (ESM), and the foundation model are compared. The physics-based single-track model (ESM) shows comparatively low accuracy with a mean squared error (MSE) of 1,885,123 and a mean absolute error (MAE) of 683, indicating systematic deviations in complex vehicle dynamics. With an MSE of 40,401 and a MAE of 125, a hybrid structure in the form of the Explainable Boosting Machine (EBM) already achieves significantly improved error reduction. The present foundation model (BVT) achieves the best performance among the tested approaches with an MSE of 30,683 and a MAE of 123, indicating higher precision in estimating the steering variable. These results make it clear that the present data-driven foundation model, in combination with a structured training strategy, allows for more accurate prediction than purely physics-based models or other hybrid methods.

In a further aspect, it is proposed that the steering variable comprises a rack force and/or a variable derived from the dynamics of the vehicle, in particular a rack support force for a predetermined trajectory.

The rack force preferably describes the force acting on the steering rack, resulting from roadway forces, driver input, and/or the steering system itself. Considering this variable may preferably allow the response force on the steering system to be modeled, which is important for steering control and assistance systems. Additionally, a variable derived from the dynamics, in particular a rack support force for a predetermined trajectory, can be detected. The rack support force preferably refers to the resulting force that arises from the contact between the rack and the housing and is influenced by the driving dynamics as well as the steering input. The inclusion of this derived variable preferably allows for a more precise assessment of steering mechanics under realistic driving conditions. The technical advantage of this approach is preferably improved modeling of steering forces, which allows vehicle stability and driving feel to be purposefully optimized.

In another aspect, it is proposed that the foundation model describes a vehicle system with up to six degrees of freedom.

The foundation model preferably describes a vehicle system with up to 6 degrees of freedom, thereby allowing a detailed representation of vehicle or robotic movement. A six-degree-of-freedom system preferably detects the translational movements in the longitudinal, lateral, and vertical axes as well as the rotations about these axes, thereby allowing all essential dynamic effects of a vehicle or a robot to be modeled. This is particularly advantageous for precisely calculating the rack force, since the forces and moments at the steering system are not considered in isolation, but rather are determined in the overall context of vehicle movement. Preferably, the foundation model architecture can be designed to be applicable to a steering rack force estimation model, thereby enabling direct implementation in steering control algorithms or driver assistance systems. By allowing for fewer than six degrees of freedom to be considered, the model can preferably be flexibly adapted to specific use cases, such as simplified simulations or real-time calculations.

In a further aspect it is proposed that the reference input comprises a longitudinal acceleration and/or a lateral acceleration and/or a vehicle speed and/or a steering angle and/or a steering angle speed and/or a rack speed and/or a motor torque and/or a hand torque and/or rack force.

The vehicle or robot speed preferably serves as a variable for determining the state of motion, which is essential for calculating the steering responses. The steering angle and steering angle speed preferably detect the direct input by the driver or an assistance system and enable a dynamic analysis of the steering angle. The rack speed preferably describes the relative movement of the rack within the steering system and provides information about the inertia and friction effects in the steering mechanism. The motor torque is preferably relevant to electrical or electromechanical steering systems, as it reflects the support performance of the steering motor. The hand torque preferably describes the direct transmission of force from the driver to the steering wheel and serves as an indicator of steering feel. The rack force preferably represents the resulting force acting on the rack and is critical for determining steering responses under different driving situations.

In a further aspect, it is proposed that the trajectory input comprises a vehicle speed and/or a steering angle.

The trajectory input preferably includes a vehicle speed and/or a steering angle, thereby giving the model a precise representation of vehicle movement. The vehicle speed preferably describes the instantaneous speed of the vehicle along its direction of movement and is a central variable for vehicle dynamics. The steering angle preferably indicates the rotational position of the front wheels relative to the vehicle's longitudinal axis and significantly affects driving behavior, in particular in cornering and steering responses. By considering these input variables, the model may preferably interpret realistic trajectory profiles and provide them for further processing in the decoder. A technical advantage of this structure preferably lies in the reduction of computational effort, since the steering response can already be derived from these two essential parameters without the need for further complex input data.

The decoder preferably receives the trajectory input and/or the representation of vehicle dynamics provided by the encoder to predict a vehicle response, in particular a rack force. The decoder is preferably a model component within the encoder-decoder architecture and combines the time-dependent input values with the learned representation of vehicle dynamics. The representation of vehicle dynamics provided by the encoder preferably aggregates various physical parameters into a latent vector space so that the decoder can perform an estimate of vehicle responses. The rack force preferably represents the resulting force on the rack and is preferably used for modeling the steering mechanism. By linking the dynamic vehicle data to the trajectory, the model may preferably achieve high accuracy in predicting steering responses.

In a further aspect, it is proposed that the decoder preferably receives the trajectory input and/or the representation of vehicle dynamics provided by the encoder to predict a vehicle response, in particular a rack force.

The number of multi-head layers of the encoder and/or the decoder may preferably be adjusted prior to training to optimally match the model architecture to the inputs to be processed. The multi-head attention mechanism in this transformer architecture preferably utilizes stacked self-attention layers that allow time-dependent inputs to be processed. The process preferably begins with an input matrix representing the time-series data, which is projected by linear transformation into query, key, and value matrices. These matrices preferably include the temporal sequence length and embed each time step into a nine-dimensional representation. The self-attention weights are preferably calculated by a matrix multiplication between the query matrix and the transposed key matrix, followed by a softmax operation that produces a probability distribution over the time steps. The normalized attention weights are preferably used to create a weighted sum of the values so that each time step can take in information from all other time steps.

In another aspect, it is proposed that the number of multi-head layers of the encoder and/or the decoder be adjusted prior to training.

Utilizing a transformer architecture preferably provides the advantage that cross-attention bridges from the encoder convey the representation of vehicle dynamics in the form of vectors V and K to the decoder. In the decoder, the cross-attention preferably utilizes both the representation of vehicle dynamics and the representation of the given trajectory to predict the rack force with high accuracy. The number of multi-head layers may preferably be experimentally adjusted to ensure optimal model performance, with certain layer configurations identified as particularly powerful in the analysis of the BVT model. The technical advantage of this adjustment capability is preferably that the model can be flexibly optimized for different amounts of data and use cases without the need for manual network restructuring. By combining the encoder-decoder model with adjustable multi-head layers, the system can preferably ensure scalable and efficient processing of complex vehicle dynamics.

In a further aspect, a control unit is also disclossed which is comprised in a vehicle having an autonomous driving function and/or a robotic system and/or an industrial machine, and on which the present method is executable in one of its aspects.

In a further aspect, a computer program comprising program code is disclosed for executing at least parts of the present method in one aspect thereof when the computer program is executed on a computer. In other words, the computer program (product) comprises commands that, when the program is executed by a computer, cause the computer to perform the steps of the method in one of its embodiments.

In a further aspect, a computer readable data carrier comprising program code of a computer program is proposed for executing at least parts of the present method in one of its aspects when the computer program is executed on a computer. In other words, the disclosure relates to a computer-readable (storage) medium comprising commands which, when executed by a computer, cause the computer to execute the method/steps of the method in one of its aspects.

The described embodiments and refinements may be combined with one another as desired.

Further possible embodiments, refinements and implementations of the disclosure also comprise combinations of features of the disclosure described previously or below with regard to the exemplary embodiments that are not explicitly mentioned.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings. The illustrated elements of the drawings are not necessarily shown to scale with respect to one another.

FIG. 1 shows a schematic flowchart of an exemplary embodiment of the method.

FIG. 2 shows a schematic block diagram of an exemplary embodiment of the present device.

FIG. 3 shows a schematic block diagram of an exemplary embodiment of the present device.

FIG. 4 shows a schematic block diagram of an exemplary embodiment of the present device.

FIG. 5 shows a schematic block diagram of an exemplary embodiment of the present device.

FIG. 6 shows a schematic block diagram of an exemplary embodiment of the present device.

FIG. 7 shows a schematic view of a training data set.

### DETAILED DESCRIPTION

In the figures of the drawings, identical reference numbers denote identical or functionally identical elements, parts or components, unless stated otherwise.

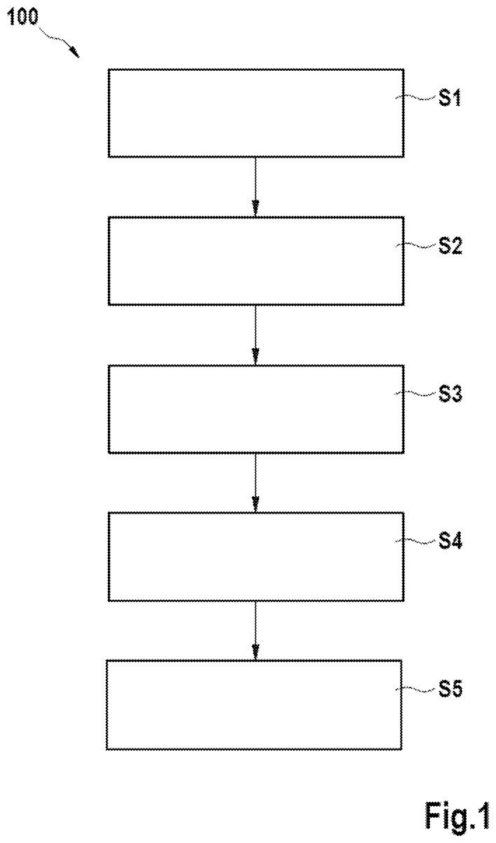

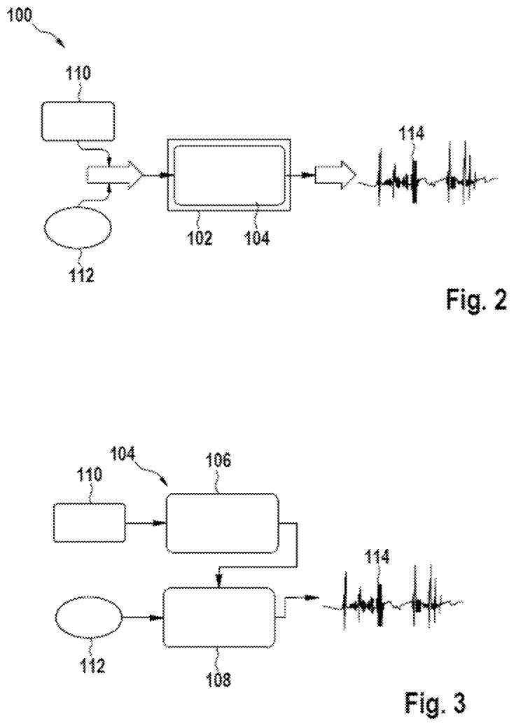

FIG. 1 shows a schematic flow chart of a method for estimating a steering variable of a steering system of a vehicle or a robot. The method will also be explained with reference to the other figures.

The method can be carried out in any embodiment, at least in part, by a device 100 which may comprise several components not shown in detail, for example one or more provision devices and/or at least one evaluation and calculation unit 102. It is understood that the provision device may be configured together with the evaluation and calculation unit 102 or may be separate from it. Furthermore, the apparatus 100, which may be part of a system, may comprise a storage device and/or an output device and/or a display device and/or an input device.

The computer-implemented method includes at least the following steps, which are executable by the evaluation and computing device 102:
In a step S1, a foundation model 104 is provided, which is structured as an encoder 106/decoder 108.

Step S2 involves supplying a reference input 110 to the encoder 106 of the foundation model 104, wherein the reference input 110 comprises physical and/or dynamic properties of the vehicle or the robot;

Step S3 involves supplying a trajectory input 112 to the decoder 108 of the foundation model 104 (see FIG. 3), wherein the trajectory input 112 comprises a trajectory of a simulation of the vehicle or the robot.

Step S4 involves processing the reference input 110 and the trajectory input 112 by the foundation model 104, wherein the encoder 106 converts the physical and/or dynamic properties of the vehicle or the robot into a latent representation in a representation space, and the decoder 108 combines the trajectory input 112 with the latent representation.

In a step S5, the steering variable 114, for example a rack force of the vehicle or the robot is estimated by the foundation model 104 based on the reference input 110 for the given trajectory. The foundation model 104 captures the context from the measured data and determines which vehicle or robot dynamics are present for the particular vehicle or robot.

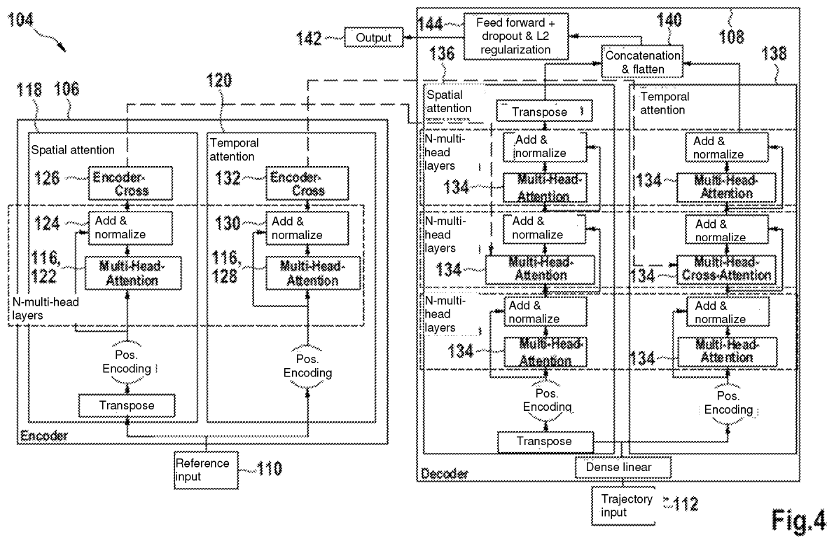

As can be seen in FIG. 4, the encoder-decoder structure of the foundation model 104 can have a multi-head layer structure 116, with a number of the multi-head layers of the encoder and/or the decoder being adjusted prior to training. The encoder 106 processes a reference input 110 that describes physical and dynamic properties of the vehicle, while the decoder 108 receives a trajectory input 112 that captures the vehicle movement over time.

The encoder 106 is divided into two major components comprising a spatial and a temporal attention layer 118, 120. Position encoding is first performed in the spatial attention layer 118 to structure the input sequence. The transposed data undergoes a multi-head attention layer 122, followed by a normalization layer 124. An encoder cross component 126 combines the calculated spatial features with other representations. The temporal attention layer 120 follows the same principle, with a focus on processing time-dependent properties. Again, a multi-head attention layer 128 is employed, which is stabilized by a normalization layer 130. The encoder cross unit 132 links the spatial and temporal representations to enable comprehensive modeling of vehicle dynamics.

The decoder 108 processes the trajectory input 112 in a comparable structure, but supplements cross-attention layers 134 to combine the vehicle dynamics provided by the encoder 106 with the current trajectory data. First, the input sequence is transposed, followed by position encoding. The spatial attention layer 136 employs a multi-head cross-attention that links the trajectory information to the vehicle dynamics. Multiple cross-attention layers 134 allow for detailed fusion of both input sources. The temporal attention layer 138 operates with a similar structure, with the temporal relationships being processed by a multi-head cross-attention. The decoder 108 passes its transformed features to a dense linear layer 140 that serves as an interface to the final prediction 142.

After processing in the decoder 108, the features from the spatial and temporal attention layers 136, 138 are merged in a linking and flattening stage. Subsequently, processing is performed by a feed-forward network with dropout and L2 regularization 144 to generate the final model predictions 142.

The multi-head attention mechanism enables efficient processing of both spatial and temporal relationships in the input data. The integration of cross-attention layers in the decoder 108 ensures that the dynamic properties of the vehicle from the encoder 106 can be purposefully combined with the trajectory information. The architecture allows for flexible adjustment of the number of multi-head layers, thereby enabling optimization of the model 104 for different applications. The hierarchical structure of spatial and temporal attention helps to predict vehicle responses with high accuracy by taking into account both the driving dynamics and the trajectory progression. The overall structure is based on a transformer architecture optimized for efficient processing of large amounts of data and complex temporal dependencies.

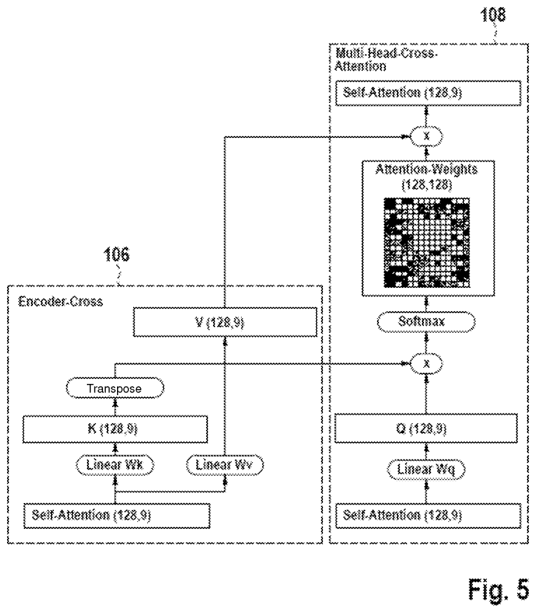

FIG. 5 shows an architecture of the foundation model 104. The transformer architecture is used. Cross-attention bridges of the encoder 106 pass on the representation of vehicle or robotic dynamics further in the form of vectors V and K. The cross-attention bridges from the decoder 108 utilize the representation of vehicle or robotic dynamics and the representation of the given trajectory to predict steering variable 114 with greater accuracy.

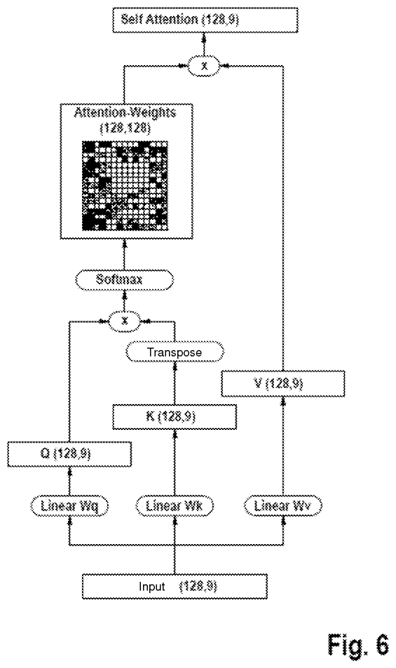

FIG. 6 shows another self-attention mechanism according to one embodiment. The input data (128, 9) are converted into vectors Q, K, V by linearization Wq, Wk, Wv. The dimension of the vectors is, for example, (128, 9). The vectors Q, K are multiplied and converted into attention weights via a softmax, for example, with the dimension (128, 128). The vector V is multiplied by the attention weights to generate the self-attention output of the dimension (128, 9).

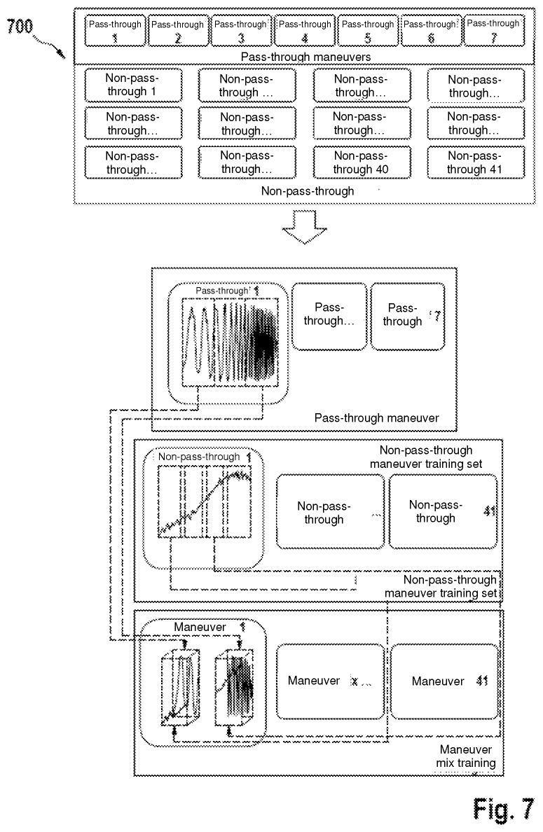

FIG. 7 shows a training dataset 700. FIG. 7 shows the structure of data preparation for training the model. The data were organized so that maneuvers with particularly representative vehicle dynamics, in particular sinus-sweep maneuvers, were kept separate. These maneuvers contain characteristic dynamic features of the vehicle or robot and are used as the reference input 110 to provide the model 104 with a comprehensive physical description of vehicle or robotic movement. The remaining data are preferably used as label and trajectory inputs to train the model 104 based on real-world driving data. For this, pairs of trajectory inputs 112 and the associated reference inputs 110 are formed so that the model 104 can learn to make precise predictions about the vehicle or robot responses from the given dynamic inputs. In FIG. 7, this concept is depicted as a maneuver mix, where the separation of the data and its specific use for optimizing model performance are provided.

What is claimed is:

1. A method for estimating a steering variable of a steering system of a vehicle, comprising:
providing a foundation model structured as an encoder-decoder;
supplying a reference input to the encoder of the foundation model, wherein the reference input comprises physical and/or dynamic properties of the vehicle;
supplying a trajectory input to the decoder of the foundation model, wherein the trajectory input includes a trajectory of a simulation of the vehicle;
processing the reference input and the trajectory input by the foundation model, wherein the encoder converts the physical and/or dynamic properties of the vehicle into a latent representation in a representation space, and the decoder combines the trajectory input with the latent representation; and
estimating the steering variable of the vehicle by the foundation model, based on the reference input for the given trajectory.

2. The method according to claim 1, wherein the steering variable includes a rack force and/or a variable derived from the dynamics of the vehicle.

3. The method according to claim 1, wherein the foundation model describes a six-degree-of-freedom system of the vehicle.

4. The method according to claim 1, wherein the reference input includes a longitudinal acceleration and/or a lateral acceleration and/or a vehicle speed and/or a steering angle and/or a steering angle speed and/or a rack speed and/or a motor torque and/or a hand torque and/or rack force.

5. The method according to claim 1, wherein the trajectory input includes a vehicle speed and/or a steering angle.

6. The method according to claim 1, wherein the decoder receives the trajectory input and/or the representation of vehicle dynamics provided by the encoder to predict a vehicle response.

7. The method according to claim 1, wherein the number of a multi-head layer of the encoder and/or the decoder is adjusted prior to training.

8. A computer program with program code to execute at least portions of the method according to claim 1 when the computer program is executed on a computer.

9. A computer-readable data carrier with program code of a computer program to execute at least portions of the method according to claim 1 when the computer program is executed on a computer.

10. A device for estimating a steering variable of a vehicle steering system, wherein the device comprises an evaluation and computing device configured to perform the following:
providing a foundation model structured as an encoder-decoder;
supplying a reference input to the encoder of the foundation model, wherein the reference input includes physical and/or dynamic properties of the vehicle;
supplying a trajectory input to the decoder of the foundation model, wherein the trajectory input includes a trajectory of a simulation of the vehicle;
processing the reference input and the trajectory input by the foundation model, wherein the encoder is configured to convert the physical and/or dynamic properties of the vehicle into a latent representation in a representation space, and the decoder is configured to combine the trajectory input with the latent representation; and
estimating the steering variable of the vehicle by the foundation model, based on the reference input for the given trajectory.

11. The method according to claim 1, wherein the steering variable includes a rack force and/or a variable derived from a rack support force for a predetermined trajectory.

12. The method according to claim 1, wherein the decoder receives the trajectory input and/or the representation of vehicle dynamics provided by the encoder to predict a rack force.

13. A computer-readable data carrier with program code of a computer program to execute the method according to claim 1 when the computer program is executed on a computer.
